(19) United States
(12) Patent Application Publication
(10) Pub. No.: US 2018/0357629 A1
(43) Pub. Date: Dec. 13, 2018

(54) ELECTRONIC SYSTEM AND METHOD FOR DISTRIBUTED PAYMENT OF A TRANSACTION

(71) Applicant: Mastercard International Incorporated, Purchase, NY (US)

(72) Inventors: Nishant Maheshwari, Aligarh (IN); Ankur Arora, New Delhi (IN); Shreya Mittal, New Delhi (IN); Manish Kumar, Gurgaon (IN)

(73) Assignee: Mastercard International Incorporated, Purchase, NY (US)

(21) Appl. No.: 16/006,632

(22) Filed: Jun. 12, 2018

(30) Foreign Application Priority Data
Jun. 12, 2017 (SG) 10201704799V

(51) Int. Cl. G06Q 20/22; G06Q 20/32; G06Q 20/10; G06Q 20/36

(52) U.S. Cl. CPC G06Q 20/29; G06Q 20/3276; G06K 7/1413; G06Q 20/367; G06Q 20/102

(57) ABSTRACT

The present disclosure generally relates to an electronic system, a computerized method, and a non-transitory computer-readable storage medium for distributed payment of a transaction between a merchant and a group of customers. Each customer has an electronic device linked to a payment instrument of the customer, and the method is implemented on a first electronic device of a first customer in the group of customers. The method comprises steps of: receiving, from a server of the merchant, an electronic bill of the transaction, the electronic bill comprising details of a number of billable items; generating a first payment data token comprising details of the payment instrument of the first customer; broadcasting a communication signal for detecting other electronic devices of the group of customers proximate to the first electronic device; receiving, from the electronic devices of one or more other customers in the group of customers, other payment data tokens in response to detection of the electronic devices, the other payment data tokens comprising details of the payment instruments of the one or more other customers; distributing the billable items in the electronic bill among the first and other payment data tokens; generating a distributed electronic bill of the transaction comprising details of the payment instruments from the distributed payment data tokens and a cost payable by each payment instrument; and communicating the distributed electronic bill to the server for subsequent processing of payment from each payment instrument, such that the transaction is collectively payable by the payment instruments corresponding to the distributed payment data tokens.

### CROSS REFERENCE TO RELATED APPLICATIONS

This application claims priority to Singapore Application Serial No. 10201704799V, filed Jun. 12, 2017, which is incorporated herein by reference in its entirety.

### TECHNICAL FIELD

The present disclosure generally relates to an electronic system and method for distributed payment of a transaction. More particularly, the present disclosure describes various embodiments of an electronic system and method for distributed payment of a transaction between a merchant and a group of customers.

### BACKGROUND

When a group of people or customers visits or patronizes a merchant such as a restaurant, pub, bar, cinema, theme park, or entertainment venue, etc., the merchant provides them with a single consolidated bill of their expenses. Normally, one representative in the group of customers will offer to pay for the consolidated bill and the remaining customers will reimburse the representative with their respective portions of the bill. The remaining customers may pay back the representative in cash, online banking, or through a mobile payment application. The customers will need to calculate the amount of money to return to the representative based on the final amount in the bill and their respective portions. The calculation can be tedious if the respective portions are not identical, such as when the customers purchase different foods in a restaurant. This problem is also accentuated if there are additional taxes to be included, resulting in odd dollars and cents.

There is current no feasible method for everyone in the group of customers to pay the bill unless individual bills are generated, which would pose additional problems for the merchant. Therefore, in order to address or alleviate at least one of the aforementioned problems and/or disadvantages, there is a need to provide an electronic system and method for distributed payment of a transaction, in which there is at least one improved feature.

### SUMMARY

According to a first aspect of the present disclosure, there is an electronic system, a computerized method, and a non-transitory computer-readable storage medium for distributed payment of a transaction between a merchant and a group of customers. Each customer has an electronic device linked to a payment instrument of the customer, and the method is implemented on a first electronic device of a first customer in the group of customers. The method comprises steps of: receiving, from a server of the merchant, an electronic bill of the transaction, the electronic bill comprising details of a number of billable items; generating a first payment data token comprising details of the payment instrument of the first customer; broadcasting a communication signal for detecting other electronic devices of the group of customers proximate to the first electronic device; receiving, from the electronic devices of one or more other customers in the group of customers, other payment data tokens in response to detection of the electronic devices, the other payment data tokens comprising details of the payment instruments of the one or more other customers; distributing the billable items in the electronic bill among the first and other payment data tokens; generating a distributed electronic bill of the transaction comprising details of the payment instruments from the distributed payment data tokens and a cost payable by each payment instrument; and communicating the distributed electronic bill to the server for subsequent processing of payment from each payment instrument, such that the transaction is collectively payable by the payment instruments corresponding to the distributed payment data tokens.

According to a second aspect of the present disclosure, there is an electronic system, a computerized method, and a non-transitory computer-readable storage medium for distributed payment of a transaction between a merchant and a group of customers. Each customer has an electronic device linked to a payment instrument of the customer. The system comprises a server of the merchant and configured for performing steps of the method, comprising: communicating, to a first electronic device of a first customer in the group of customers, an electronic bill of the transaction, the electronic bill comprising details of a number of billable items; receiving, from the first electronic device, a distributed electronic bill of the transaction, wherein the billable items are distributed among one or more payment data tokens of the customers, each payment data token comprising details of a payment instrument of the customer; communicating, to a payment network, details of the payment instruments from the distributed payment data tokens and a cost payable by each payment instrument for subsequent processing of payment from each payment instrument, wherein the transaction is collectively payable by the payment instruments corresponding to the distributed payment data tokens.

An electronic system and method for distributed payment of a transaction according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1A and FIG. 1B are illustrations of an electronic system for distributed payment of a transaction, in accordance with embodiments of the present disclosure.

FIG. 2 is a flowchart illustration of a computerized method for distributed payment of a transaction, in accordance with embodiments of the present disclosure.

FIG. 3 is a block diagram illustration of the technical architecture of a server of the electronic system of FIG. 1, in accordance with embodiments of the present disclosure.

### DETAILED DESCRIPTION

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “I” in a figure or associated text is understood to mean “and/or” unless otherwise indicated. For purposes of brevity and clarity, descriptions of embodiments of the present disclosure are directed to an electronic system and method for distributed payment of a transaction, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, known systems, methods, procedures, and components have not been described in detail so as to not unnecessarily obscure aspects of the embodiments of the present disclosure.

### System Overview

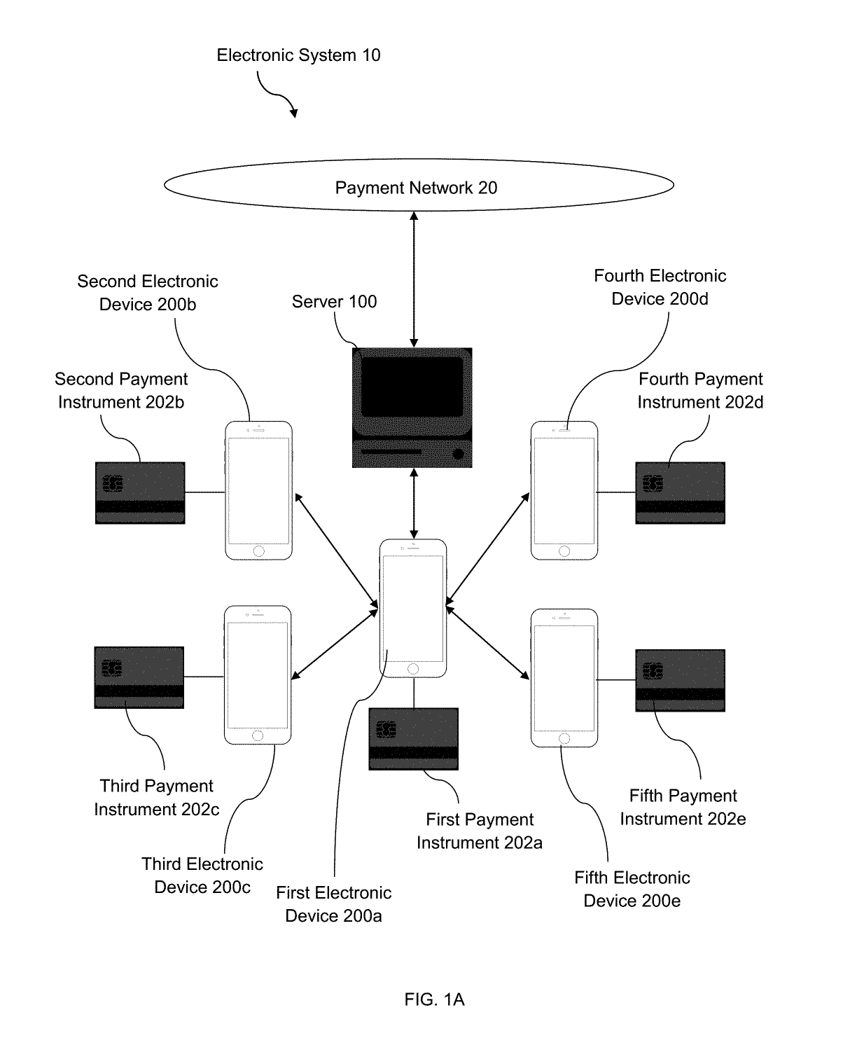

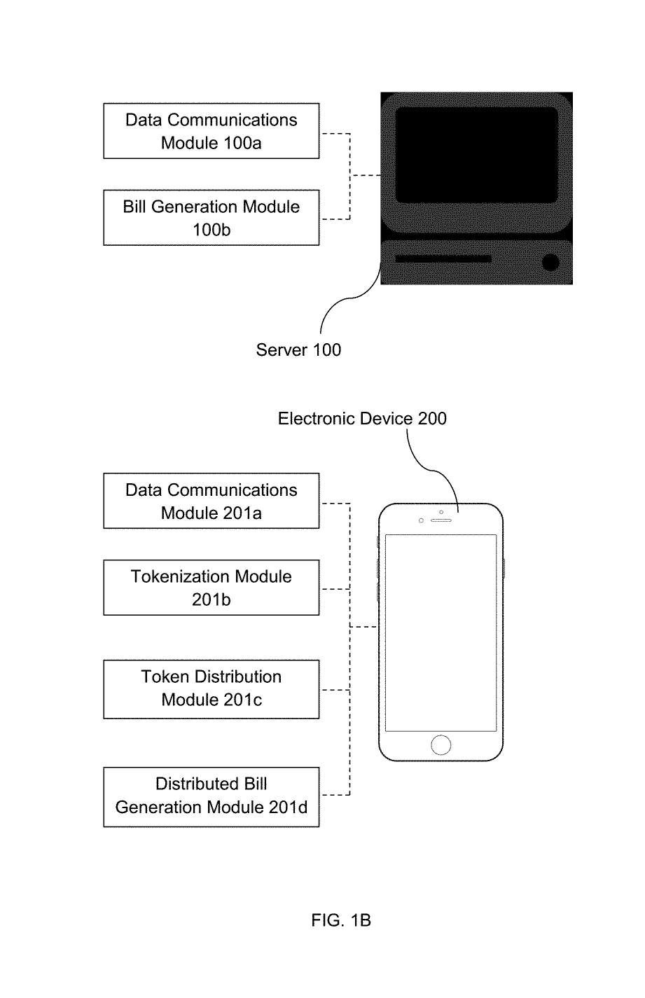

In representative or exemplary embodiments of the present disclosure, there is provided an electronic system 10 as illustrated in FIG. 1A and FIG. 1B. The system 10 includes a server 100 having a processor and a data storage device or memory configured to store computer-readable instructions. The server 100 is operative by a merchant for performing transactions between the merchant and customers, including for distributed payment of a transaction by a group of customers.

Each customer in the group of customers holds an electronic device 200 that includes or is linked to a payment instrument 202. In a transaction between the merchant and the group of customers, such as paying for dinner at a restaurant or purchase of multiple movie tickets in a cinema, one of the electronic devices 200 (first electronic device 200a) receives an electronic bill of the transaction from the server 100. Communications between the server 100 and the electronic devices 200 occur between a data communication module 100a of the server and a data communication module/component 201a of each electronic device 200. The electronic bill, which is calculated and generated by a bill generation module/component 100b of the server 100, contains a list of the billable items, such as the food items in the dinner or a list of the purchased movie tickets. The electronic bill may be communicated from the server 100 to the first electronic device 200a by displaying a barcode, e.g. QR code, for the first electronic device 200a to read or scan.

Each electronic device 200 includes a tokenization module/component 201b for generating payment tokens that include details of payment instruments 202. After receiving the electronic bill, the first electronic device 200a then generates a first payment token that includes details of the payment instrument 202 of the customer holding the first electronic device 200a (first customer). After receiving the electronic bill, the first electronic device 200a broadcasts a communication signal for detecting other electronic devices 200. When another electronic device 200 is proximate to the first electronic device 200a, i.e. within the broadcast range of the communication signal, a payment token from the other electronic device 200 is communicated to the first electronic device 200a. The other payment tokens include details of the payment instruments 202 of the other customers in the group of customers.

The first customer then uses the first electronic device 200a to distribute the billable items in the electronic bill among the payment data tokens. Particularly, the billable items are allocated to the customers such that each customer is responsible to pay for their rightful portion of the electronic bill. A distributed electronic bill of the transaction is subsequently generated, specifically by a distributed bill generation module/component 201d. As any one of the electronic devices 200 is configurable as the first electronic device 200a, each electronic device 200 includes a token distribution module/component 201c for distributing the billable items in the electronic bill among the payment data tokens, as well as the distributed bill generation module 201d for calculating and generating the distributed electronic bill. The distributed electronic bill is collectively payable by the payment instruments 202 of the group of customers. The first electronic device 200a then communicates the distributed electronic bill, including details of the payment instruments 202 from the payment data tokens, to the server 100 for subsequent processing of payment from each payment instrument 202.

The system 10 includes a payment network 20 communicatively linked to the server 100. The server 100 communicates the details of each payment instrument 202 to the payment network 20 for processing of payment. Specifically, payment from each payment instrument 202 is processed independently such that there are multiple sub-transactions to pay for the electronic bill of this transaction. Each sub-transaction occurs between the merchant and one of the customers, such that all in the group of customers collectively pay for the transaction. Accordingly, payment of the transaction is distributed among the group of customers.

Thus, even though the merchant issues a single bill for the transaction, e.g. dinner or movie tickets, each customer can pay for their own portion of the bill. This obviates the need for one representative customer to pay on behalf of the rest and then having the rest paying back their portions to the representative customer.

### Terms Description

As used herein, a “payment network 20” may be exemplarily described as a system network for settling financial transactions. The payment network 20 may be operated by an organization such as a payment card or credit card association, e.g. MasterCard® or Visa®. The payment network 20 connects or links together multiple financial institutions, particularly issuer banks and acquirer banks for processing payment of the transactions between merchants and customers.

As used herein, an “electronic device 200” may be exemplarily described as a mobile device such as a mobile phone, smartphone, personal digital assistant (PDA), tablets, laptop, or computer.

As used herein, an “electronic bill” may be exemplarily described as a statement of money owed to a merchant for products/goods/services supplied by the merchant, wherein the statement is presented in an electronic or digital format.

As used herein, a “payment instrument 202” may be exemplarily described as any suitable cashless payment mode or mechanism, such as payment cards. Payment cards may include credit cards, debit cards, prepaid cards, and/or charge cards which the customer uses to pay for transactions. In addition to payment cards, payment instruments may include, but are not limited to, membership cards, promotional cards, frequent flyer cards, identification cards, gift cards, and/or any other payment cards that may hold payment card information and which may be stored electronically.

As used herein, a “payment data token” may be exemplarily described as a non-sensitive data element that is generated by a tokenization process from a sensitive data element, such as payment instrument details. The “payment data token” functions as a reference or identifier that maps back to the sensitive data element (payment instrument details) through a tokenization system, as will be readily understood by the skilled person. Furthermore, various embodiments describe multiple electronic devices 200, each with its payment instrument 202 and payment data token. For clarity, the first electronic device 200a is associated with the first payment instrument 202a and the first payment data token, and so forth for the other ordinals.

### Method Steps

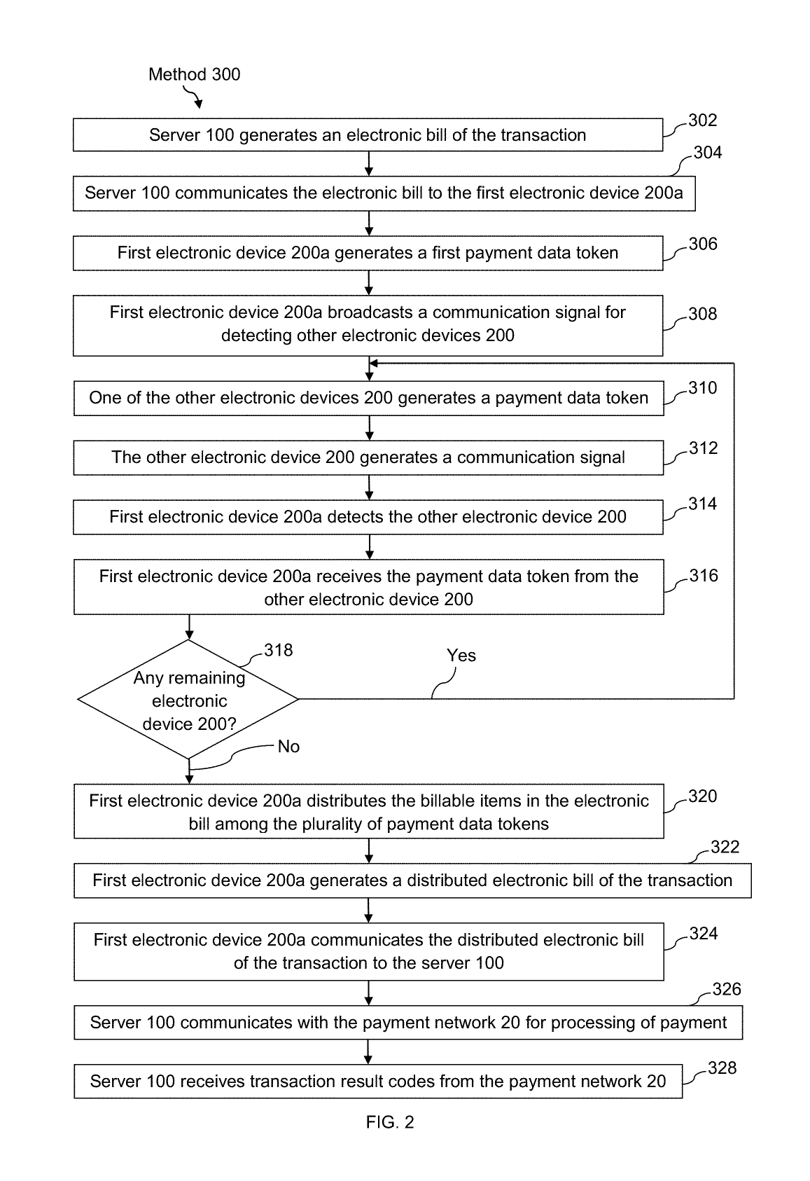

In various embodiments further with reference to FIG. 2, there is shown a computer-implemented or computerized method 300, i.e. implemented on the system 10, for distributed payment of a transaction. The transaction occurs between a merchant and a group of customers. In a first example, the transaction is for a dinner at a restaurant wherein the restaurant issues a single bill and each customer can pay directly to the restaurant for their own portion of the dinner. In a second example, the transaction is a purchase of multiple tickets, e.g. for a movie, concert, or other event, from the merchant, e.g. a cinema, theatre, or other entertainment venue, wherein the entertainment venue issues a single bill and each customer can pay directly to the entertainment venue for their own ticket. Accordingly, the group of customers collectively pays for the transaction, or in other words, payment of the transaction is distributed among the group of customers.

Following on the previous examples, at the end of the dinner or after the ticket details have been finalized, in a step 302 of the method 300, the server 100 of the merchant generates, with the bill generation module 100b, an electronic bill of the transaction. The electronic bill includes details of a number of billable items of the transaction. In the dinner example, the billable items refer to the dishes (e.g. food/drinks/sides/desserts) ordered by the customers and the cost of each dish. In the ticket example, the billable items refer to the tickets purchased by the customers and the cost of each ticket. The electronic bill may further include service charges and/or taxes, e.g. value-added tax (VAT), on top of the total cost of the billable items. Examples of an electronic bill are shown in Tables 1A and 1 B below.

TABLE 1A
Electronic bill for a dinner at a restaurant

| Billable Item | Cost |
|---|---|
| Burger | $20 |
| Fish and chips | $25 |
| Steak | $40 |
| Grilled fish | $30 |
| Salad | $15 |
| Beer tower | $80 |
| Service charge (e.g. 10%) | $21 |
| Tax (e.g. 7%) | $16.17 |
| Total | $247.17 |

TABLE 1B
Electronic bill for purchasing multiple tickets

| Billable Item | Cost |
|---|---|
| Ticket 1 | $50 |
| Ticket 2 | $50 |
| Ticket 3 | $50 |
| Ticket 4 | $50 |
| Ticket 5 | $50 |
| Total | $250 |

Each customer in the group of customers holds an electronic device 200. Each electronic device 200 includes or is linked to one or more payment instruments 202 of the respective customer, such that the electronic device 200 is configured and operative as a digital wallet and allows the customer to pay for transactions. The digital wallet may be operated on a software application executable on the electronic device 200. An example of a digital wallet is MasterPass® by MasterCard®. Details of the payment instruments 202 may be stored locally on the electronic device 200 or retrieved remotely with the electronic device 200.

With reference to FIG. 1A, the system 10 further includes a plurality of electronic devices 200 belonging to the group of customers. In one embodiment, there are five customers patronizing the merchant, each customer holding an electronic device 200. Specifically, a first customer holds a first electronic device 200a linked to a first payment instrument 202a, a second customer holds a second electronic device 200b linked to a second payment instrument 202b, a third customer holds a third electronic device 200c linked to a third electronic payment instrument 202c, a fourth customer holds a fourth electronic device 200d linked to a fourth payment instrument 202d, and a fifth customer holds a fifth electronic device 200e linked to a fifth payment instrument 202e. One customer in the group of customers, i.e. the first customer, is a representative customer or primary transactor for paying for the transaction with the merchant on behalf of everyone in the group of customers.

Although various embodiments are described for five customers with five electronic devices 200, it will be appreciated that there can be any number of customers, i.e. two or more, in the group of customers for distributed payment of a transaction between a merchant and the group of customers.

Referring to FIG. 2, in a step 304 of the method 300, the server 100 communicates the electronic bill to the first electronic device 200a, specifically between the data communication modules 100a and 201a. In one embodiment, the first electronic device 200a reads or scans a barcode, e.g. conventional single-line barcode or a two-dimensional matrix code (QR code), and receives the electronic bill from the server 100. The barcode is generated by the server 100 for this particular transaction and may be valid for a predefined duration after being generated. After the predefined duration (e.g. 60 seconds) lapses, the barcode is invalidated and reading or scanning of the barcode would not lead to retrieval of the electronic bill. The barcode may be displayed on a merchant electronic device, such as a smartphone or tablet, and brought to the first customer by a merchant employee. In another embodiment, the electronic bill is encoded in the form of near field communication (NFC) data and communicated to the first electronic device 200a when the first electronic device 200a is near a merchant electronic device. This merchant electronic device may be a merchant billing machine, point-of-sale (POS) terminal, or merchant terminal.

After receiving the electronic bill, a summary of the billable items is displayed on the first electronic device 200a such that the first customer can subsequently distribute the billable items for collective payment by the group of customers. In a step 306, the first customer initiates a function on the first electronic device 200a to generate a payment data token with the tokenization module 201b. The function may be referred to as an “Authorized to Pay” function embedded in a software application or operating system of the first electronic device 200a. The payment data token includes details of the payment instrument of the first customer. For clarity, this payment data token of the first customer is referred to as the first payment data token and includes details of the first payment instrument 202a.

A payment data token may be referred to as a tokenized variant of the corresponding payment instrument 202. Sensitive data elements associated with details of the payment instrument 202 are substituted with a non-sensitive equivalent in the payment data token for secure communication in an encrypted form.

In a step 308, the first electronic device 200a broadcasts or transmits a communication signal with the data communication module 201a for detecting other electronic devices 200 proximate to the first electronic device 200a. The communication signal is continuously or continually broadcasted by the first electronic device 200a and has a limited broadcast range to detect nearby electronic devices 200. Particularly, the communication signal is an active communication signal that searches for other electronic devices 200b/c/d/e of the group of customers.

In a step 310, one of the other electronic devices 200b/c/d/e generates a payment data token with the respective tokenization module 201b, each payment data token including details of the corresponding payment instrument 202b/c/d/e. For example, the second customer initiates an “Authorized to Pay” function on the second electronic device 200b to generate a second payment data token that includes details of the second payment instrument 202b. Like the first payment data token, the second payment data token is a tokenized variant of the second payment instrument 202b for secure communication in an encrypted form.

In a step 312, the other electronic device 200b/c/d/e broadcasts a communication signal with the respective data communication module 201a for detecting electronic devices 200, specifically the first electronic device 200a. To avoid confusion, this communication signal broadcasted from the other electronic device 200b/c/d/e may be referred to as a passive communication signal. In the example of the second electronic device 200b, the second payment data token is carried in the form of a data packet by the passive communication signal broadcasted thereby. When the second customer places the second electronic device 200b close enough to the first electronic device 200a, the active communication signal and passive communication signal are within broadcast range of each other, enabling the first electronic device 200a to detect the second electronic device 200b.

Accordingly, the method 300 includes a step 314 of detecting one of the other electronic devices 200b/c/d/e by the first electronic device 200a, specifically with the data communication module 201a. The detection of the other electronic device 200b/c/d/e by the first electronic device 200a enables both devices to engage each other and become communicative with each other. In a step 316 and using the example of the second electronic device 200b, the second payment data token carried by the passive communication signal is communicated to and received by the data communication module 201a of the first electronic device 200a in response to detection of the second electronic device 200b. Communication between the first electronic device 200a and second electronic device 200b may occur via known contactless/wireless communication protocols, such as Wi-Fi, NFC, or Bluetooth.

The steps 310, 312, 314, and 316 are iterated for each of one or more of the other electronic devices 200b/c/d/e of the group of customers. A step 318 of the method 300 determines whether there is any remaining electronic device 200b/c/d/e that has not communicated the payment data token to the first electronic device 200a. In one embodiment, all five customers in the group of customers share the total cost of the electronic bill. The steps 310, 312, 314, and 316 would be repeated for the second electronic device 200b, third electronic device 200c, fourth electronic device 200d, and fifth electronic device 200e. In another embodiment, one customer, e.g. the fifth customer, in the group of customers is not required to pay, such as because the other customers are giving him/her a treat. The steps 310, 312, 314, and 316 would be repeated for the second electronic device 200b, third electronic device 200c, and fourth electronic device 200d.

Accordingly, if the step 318 determines that there is a remaining electronic device 200b/c/d/e that needs to but has not communicated the payment data token to the first electronic device 200a, the step 318 returns to the step 310 for this remaining electronic device 200b/c/d/e.

Conversely, if the step 318 determines that there is no remaining electronic device 200b/c/d/e, this means that the first electronic device 200a has received all the required other payment data tokens from the other electronic devices 200b/c/d/e and the step 318 proceeds to a step 320 described below. The first electronic device 200a stores a plurality of payment data tokens and each payment data token is associated with the respective payment instrument 202. Notably, the plurality of payment data tokens includes the other payment data tokens as well as the first payment data token generated in the step 306. Each of the other payment data tokens may be valid for a predefined duration as determined by the respective customer with the respective electronic device 200b/c/d/e. Allowing the other payment data tokens to be valid for the predefined duration, or in other words temporarily stored on the first electronic device 200a, prevents the first customer from using (or abusing) the other payment data tokens for other transactions. For example, after the predefined duration (e.g. 60 seconds) lapses, the other payment data tokens are automatically invalidated or erased from the first electronic device 200a.

In the step 320 of the method 300, the first customer uses the first electronic device 200a, specifically the token distribution module 201c, to distribute the billable items in the electronic bill among the plurality of payment data tokens. In one embodiment, each payment data token includes an identifier that is displayed on the first electronic device 200a together with the billable items. The identifier may include an alias of the respective customer that allows the first customer to uniquely identify the other customers and distribute the billable items accordingly.

In one embodiment of the step 320, distributing the billable items includes allocating or assigning each billable item to at least one identifier from the payment data tokens. Following on the dinner and ticket examples above, Tables 2A and 2B below show the allocation of the billable items to the identifiers.

TABLE 2A
Distribution of electronic bill for a dinner at a restaurant

| Billable Item | Cost | Allocation |
|---|---|---|
| Burger | $20 | Identifier of first customer |
| Fish and chips | $25 | Identifier of second customer |
| Steak | $40 | Identifier of third customer |
| Grilled fish | $30 | Identifier of fourth customer |
| Salad | $15 | Identifier of fifth customer |
| Beer tower | $80 | Identifiers of all five customers |
| Service charge (e.g. 10%) | $21 | Not applicable |
| Tax (e.g. 7%) | $16.17 | Not applicable |
| Total | $247.17 | Not applicable |

TABLE 2B
Distribution of electronic bill for purchasing multiple tickets

| Billable Item | Cost | Allocation |
|---|---|---|
| Ticket 1 | $50 | Identifier of first customer |
| Ticket 2 | $50 | Identifier of second customer |
| Ticket 3 | $50 | Identifier of third customer |
| Ticket 4 | $50 | Identifier of fourth customer |
| Ticket 5 | $50 | Identifiers of first, second, third, |
| | | and fourth customers |
| Total | $250 | Not applicable |

It can be noted from Table 2A that each customer pays for their respective dish and the cost of the billable item “Beer tower” is shared among all five customers. Furthermore, the service charge and tax amounts are automatically calculated and equally shared among all five customers.

It can be noted from Table 2B that the cost of the billable item “Ticket 5” is shared among the first to fourth customers. In other words, the first to fourth customers are treating the fifth customers to the ticket. No billable item is allocated to the identifier of the fifth customer. Alternatively, the fifth electronic device 200e of the fifth customer does not communicate the fifth payment data token to the first electronic device 200a.

It will be appreciated that in another embodiment of the step 320, distributing the billable items includes allocating or assigning each identifier of the customer from the payment data tokens to at least one billable item. Tables 3A and 3B below show the allocation of the identifiers to the billable items.

TABLE 3A
Distribution of electronic bill for a dinner at a restaurant

| Billable Items | Allocation |
|---|---|
| Burger and Beer tower | Identifier of first customer |
| Fish and chips and Beer tower | Identifier of second customer |
| Steak and Beer tower | Identifier of third customer |
| Grilled fish and Beer tower | Identifier of fourth customer |
| Salad and Beer tower | Identifier of fifth customer |

TABLE 3B
Distribution of electronic bill for purchasing multiple tickets

| Billable Items | Allocation |
|---|---|
| Ticket 1 and Ticket 5 | Identifier of first customer |
| Ticket 2 and Ticket 5 | Identifier of second customer |
| Ticket 3 and Ticket 5 | Identifier of third customer |
| Ticket 4 and Ticket 5 | Identifier of fourth customer |
| None/N.A. | Identifier of fifth customer |

After the step 320 of distributing the billable times among the plurality of payment data tokens, the first customer, in a step 322, initiates a function on the first electronic device 200a to finalize the distribution and generate a distributed electronic bill of the transaction with the distributed bill generation module 201d. This distributed electronic bill includes details of the payment instruments 202 corresponding to the distributed payment data tokens and the amount or cost payable by each payment instrument 202, such that the transaction is collectively payable by the payment instruments 202.

In a step 324, the first customer uses the first electronic device 200a to communicate the distributed electronic bill to the server 100. Particularly, first electronic device 200a communicates with the server 100 via a merchant terminal. For example, the first customer places the electronic device 200a near the merchant terminal for communicative engagement with the data communication module 201a and by known contactless/wireless communication protocols, such as NFC. The distributed electronic bill is communicated to the server 100 for subsequent processing of payment of the respective amount/cost from each payment instrument 202. Tables 4A and 4B below summarizes the amount payable by each customer with the respective payment instrument 202, including the relevant service charge and tax.

TABLE 4A
Amount payable by each customer for a dinner at a restaurant

| Customer | Amount Payable |
|---|---|
| First customer | $42.37 |
| Second customer | $48.26 |
| Third customer | $65.91 |
| Fourth customer | $54.14 |
| Fifth customer | $36.49 |
| Total | $247.17 |

TABLE 4B
Amount payable by each customer for purchasing multiple tickets

| Customer | Amount Payable |
|---|---|
| First customer | $62.50 |
| Second customer | $62.50 |
| Third customer | $62.50 |
| Fourth customer | $62.50 |
| Fifth customer | $0 |
| Total | $250 |

In a step 326, the server 100 communicates, to the payment network 20, details of the payment instruments 202 for subsequent processing of payment from each payment instrument 202. It will be appreciated that the processing of transactions in the payment network 20 is performed in a standard manner and will be readily understood by the skilled person.

The distributed electronic bill of the transaction provides the merchant with details of the payment instrument 202 and the amounts payable by each customer with the payment instruments 202. Payment from each payment instrument 202 is processed independently from one another such that there are multiple sub-transactions to pay for this transaction. In each sub-transaction, the server 100 generates sub-transaction data that includes details of the payment instrument 202a/b/c/d/e and the payable amount to the payment network 20. The server 100 communicates the sub-transaction data of the multiple sub-transactions to the payment network 20 which then processes each sub-transaction in a standard manner. In a step 328, transaction result codes for the sub-transactions are communicated from the payment network 20 to the server 100, which collectively indicate that the total cost of the transaction has been collectively paid by the payment instruments 202 and the transaction is successfully completed.

Therefore, in both the dinner and ticket examples, even though the merchant issues a single bill for the transaction, each customer can pay for their own portion of the bill. This obviates the need for one representative customer to pay on behalf of the rest and then having the rest paying back their portions to the representative customer. Any relevant service fee or tax is automatically calculated so that the customers do not need to manually calculate the exact amount to return to the representative customer. Moreover, each customer can use their own payment instrument, e.g. credit card, to pay for their portion of the bill with the merchant and earn credit card rebates at the same time. The merchant also has an advantage in that the merchant does not need to issue multiple bills for each customer; a single bill can be paid for by payments from the multiple sub-transactions.

### Technical Architecture

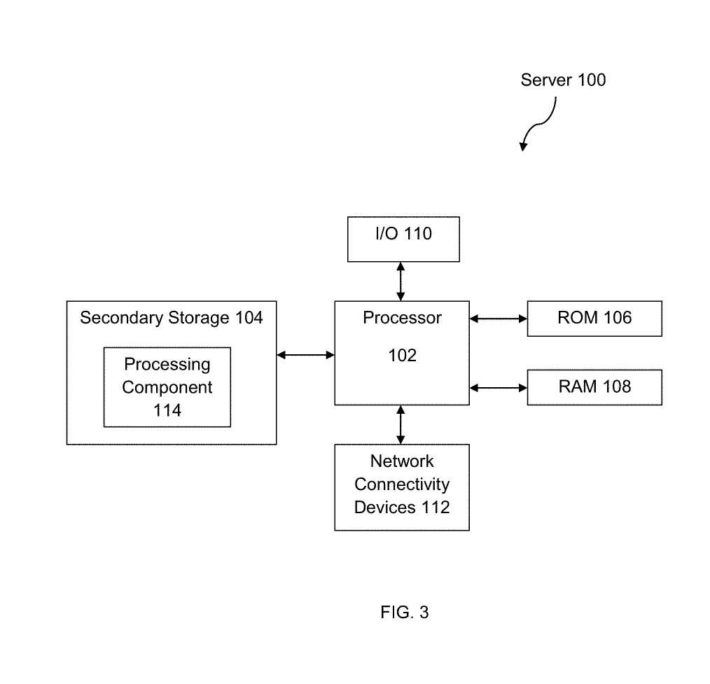

The following is a description of the technical architecture of the server 100 with reference to FIG. 3. It will be appreciated that the electronic device 200 may have a similar technical architecture as well.

The technical architecture of the server 100 includes a processor 102 (also referred to as a central processor unit or CPU) that is in communication with memory devices including secondary storage 104 (such as disk drives or memory cards), read only memory (ROM) 106, and random access memory (RAM) 108. The processor 102 may be implemented as one or more CPU chips. Various modules or components for performing various operations or steps of the method 300 are configured as part of the processor 102 and such operations or steps are performed in response to non-transitory instructions operative or executed by the processor 102.

The technical architecture further includes input/output (I/O) devices 110, and network connectivity devices 112. The secondary storage 104 typically includes a memory card or other storage device and is used for non-volatile storage of data and as an over-flow data storage device if RAM 108 is not large enough to hold all working data. Secondary storage 104 may be used to store programs which are loaded into RAM 108 when such programs are selected for execution.

The secondary storage 104 has a processing component 114, including non-transitory instructions operative by the processor 102 to perform various operations or steps of the method 300 according to various embodiments of the present disclosure. The ROM 106 is used to store instructions and perhaps data which are read during program execution. The secondary storage 104, the ROM 106, and/or the RAM 108 may be referred to in some contexts as computer-readable storage media and/or non-transitory computer-readable media. Non-transitory computer-readable media include all computer-readable media, with the sole exception being a transitory propagating signal per se.

The I/O devices 110 may include printers, video monitors, liquid crystal displays (LCDs), plasma displays, touch screen displays, keyboards, keypads, switches, dials, mice, track balls, voice recognizers, card readers, paper tape readers, and/or other known input devices.

The network connectivity devices 112 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communication (NFC), radio frequency identity (RFID), and/or other air interface protocol radio transceiver cards, and other known network devices. These network connectivity devices 112 may enable the processor 102 to communicate with the Internet or one or more intranets. With such a network connection, it is contemplated that the processor 102 might receive information from the network, or might output information to the network in the course of performing the operations or steps of the method 300. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors.

It will be appreciated that the technical architecture of the server 100 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture of the server 100, at least one of the CPU 102, the ROM 106, and the RAM 108 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by known design rules.

In the foregoing detailed description, embodiments of the present disclosure in relation to an electronic system and method for distributed payment of a transaction are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A computerized method for distributed payment of a transaction between a merchant and a group of customers, each customer having an electronic device linked to a payment instrument of the customer, the method implemented on a first electronic device of a first customer in the group of customers, the method comprising steps of:
receiving, from a server of the merchant, an electronic bill of the transaction, the electronic bill comprising details of a number of billable items;
generating a first payment data token comprising details of the payment instrument of the first customer;
broadcasting a communication signal for detecting other electronic devices of the group of customers proximate to the first electronic device;
receiving, from the electronic devices of one or more other customers in the group of customers, other payment data tokens in response to detection of the electronic devices, the other payment data tokens comprising details of the payment instruments of the one or more other customers;
distributing the billable items in the electronic bill among the first and other payment data tokens;
generating a distributed electronic bill of the transaction comprising details of the payment instruments from the distributed payment data tokens and a cost payable by each payment instrument; and
communicating the distributed electronic bill to the server for subsequent processing of payment from each payment instrument, such that the transaction is collectively payable by the payment instruments corresponding to the distributed payment data tokens.

2. The method according to claim 1, wherein each electronic device is a mobile device configured as a digital wallet with the respective payment instrument.

3. The method according to claim 1, wherein the electronic bill is received from the server in response to the first electronic device reading a barcode generated by the server for the transaction.

4. The method according to claim 3, wherein the barcode is valid for a predefined duration after being generated by the server.

5. The method according to claim 1, wherein each payment data token comprises an identifier displayed on the first electronic device for distribution of the billable items.

6. The method according to claim 5, wherein distributing the billable items comprises allocating each billable item to at least one identifier.

7. The method according to claim 5, wherein distributing the billable items comprises allocating each identifier to at least one billable item.

8. The method according to claim 1, wherein for each of the electronic devices of the one or more other customers, the payment data token is carried by a communication signal broadcasted therefrom.

9. The method according to claim 8, wherein the first electronic device automatically detects another electronic device when the respective communication signals are within a broadcast range of each other.

10. The method according to claim 8, wherein the payment data tokens are carried in an encrypted form by the communication signals broadcasted from the electronic devices of the one or more other customers.

11. A non-transitory computer-readable storage medium storing computer-readable instructions that, when executed, cause a first electronic device to perform steps of a method according to claim 1.

12. A computerized method for distributed payment of a transaction between a merchant and a group of customers, each customer having an electronic device linked to a payment instrument of the customer, the method implemented on a server of the merchant, the method comprising steps of:
communicating, to a first electronic device of a first customer in the group of customers, an electronic bill of the transaction, the electronic bill comprising details of a number of billable items;
receiving, from the first electronic device, a distributed electronic bill of the transaction, wherein the billable items are distributed among one or more payment data tokens of the customers, each payment data token comprising details of a payment instrument of the customer;
communicating, to a payment network, details of the payment instruments from the distributed payment data tokens and a cost payable by each payment instrument for subsequent processing of payment from each payment instrument,
wherein the transaction is collectively payable by the payment instruments corresponding to the distributed payment data tokens.

13. The method according to claim 12, the steps further comprising generating a barcode for the transaction.

14. The method according to claim 13, wherein the electronic bill is communicated to the first electronic device in response to the first electronic device reading the barcode.

15. The method according to claim 13, wherein the barcode is valid for a predefined duration after being generated.

16. The method according to claim 12, the steps further comprising generating sub-transaction data for a plurality of sub-transactions of the transaction, each sub-transaction data comprising details of the payment instrument from one distributed payment data token and the respective cost payable by the payment instrument.

17. The method according to claim 16, wherein each sub-transaction is processed by the payment network independently from one another.

18. The method according to claim 16, the steps further comprising receiving, from the payment network, a transaction result code for each sub-transaction, wherein the transaction result codes collectively indicate completion of the transaction.

19. A non-transitory computer-readable storage medium storing computer-readable instructions that, when executed, cause a server to perform steps of a method according to claim 12.

20. An electronic system for distributed payment of a transaction between a merchant and a group of customers, each customer having an electronic device linked to a payment instrument of the customer, the system comprising a server of the merchant and configured for performing steps comprising:
communicating, to a first electronic device of a first customer in the group of customers, an electronic bill of the transaction, the electronic bill comprising details of a number of billable items;
receiving, from the first electronic device, a distributed electronic bill of the transaction, wherein the billable items are distributed among one or more payment data tokens of the customers, each payment data token comprising details of a payment instrument of the customer;
communicating, to a payment network, details of the payment instruments from the distributed payment data tokens and a cost payable by each payment instrument for subsequent processing of payment from each payment instrument,
wherein the transaction is collectively payable by the payment instruments corresponding to the distributed payment data tokens.
